(19) United States
(12) Patent Application Publication
(10) Pub. No.: US 2024/0231799 A1
(43) Pub. Date: Jul. 11, 2024

(54) METHOD AND SYSTEM FOR GENERATING RECOMMENDATIONS FOR ENHANCEMENT OF AN EXISTING APPLICATION

(71) Applicant: HCL Technologies Limited, New Delhi (IN)

(72) Inventors: PRAVEEN DUSTONKRISHNAKUMARI, Chennai (IN); Maheswari V. S, Chennai (IN); Hareendran M, Chennai (IN)

(21) Appl. No.: 18/396,758

(22) Filed: Dec. 27, 2023

(30) Foreign Application Priority Data
Dec. 31, 2022 (IN) 202311000030

(51) Int. Cl. G06F 8/65; G06Q 10/0635

(52) U.S. Cl. CPC G06F 8/65; G06Q 10/0635

(57) ABSTRACT

The disclosure relates to a method and system of generating recommendations for enhancement of an existing application. The method may include assessing the existing application based on at least one of: one or more application assessment parameters to determine an application weightage score, one or more business assessment parameters to determine a business weightage score, and one or more risk-assessment parameters, to determine a risk weightage score. The method may further include calculating a threshold score based on the application weightage score, the business weightage score, and the risk weightage score, and selecting one of a plurality of predefined recommendations for the existing application, based on the threshold score.

### TECHNICAL FIELD

This disclosure relates generally to enhancement of an existing application, and in particular to generating recommendations for enhancement of an existing legacy or monolith application.

### BACKGROUND

The term Brownfield software development is related to development of new software systems within the presence of existing or legacy software applications and services. The new software or services can coexist and run along with the existing software or applications. A brownfield application could be a new enhancement or a feature on an existing live production application, for example, a new module added in an existing application or a new feature integrated with an application that was developed earlier. Therefore, an application become a Brownfield application sooner or later if the application is already developed. The Brownfield application could be a Legacy (mainframe-based applications, COBOL, C, C++) or a Monolith (open system based with tech stack like Java or .NET) application.

Some common characteristics of Brownfield applications include slow but reliable changes, on-premise workload deployments, tightly coupled applications, huge subject matter expert (SME) dependencies and contributions, follow Waterfall model for release cycles, inflexibility or lack of scalability, and security and performance pitfalls. Due to these, Brownfield applications face various challenges in enhancements, for example, challenges in the development of new functionalities or enhancements on the brownfield applications. While implementing new features on the Brownfield applications, various factors and parameters need to be considered in such a way that development of new functionalities should not fall under failure case.

For example, consider a legacy or monolith application in which new enhancements are planned to be implemented on the same codebase wherein existing application is already facing certain issues and the business is struggling to maintain it. Adding new features on such an application might be a wrong decision which may further impact the business and lead to failures. However, no clear directions or solutions available on the questions: When to do the enhancement on the existing application?, When to choose a separate application for new enhancements?, Will the application remain stable after enhancements?, and was it a right decision.

Therefore, there is a need for solutions for suggesting an effective and accurate recommendations on new enhancements in Brownfield application.

### SUMMARY

In an embodiment, a method of generating recommendations for enhancement of an existing application is disclosed. The method may include assessing the existing application based on at least one of: one or more application assessment parameters to determine an application weightage score, one or more business assessment parameters to determine a business weightage score, and one or more risk-assessment parameters, to determine a risk weightage score. The method may further include calculating a threshold score based on the application weightage score, the business weightage score, and the risk weightage score, and selecting one of a plurality of predefined recommendations for the existing application, based on the threshold score.

In another embodiment, a system for generating recommendations for enhancement of an existing application is disclosed. The system includes a processor and a memory. The memory stores a plurality of processor-executable instructions, which upon execution, cause the processor to assess the existing application based on at least one of: one or more application assessment parameters to determine an application weightage score, one or more business assessment parameters to determine a business weightage score, and one or more risk-assessment parameters, to determine a risk weightage score. The plurality of processor-executable instructions, upon execution, further cause the processor to calculate a threshold score based on the application weightage score, the business weightage score, and the risk weightage score, and select one of a plurality of predefined recommendations for the existing application, based on the threshold score.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating recommendations for enhancement of an existing application, in accordance with some embodiments of the present disclosure.

FIG. 2 illustrates a block diagram of the recommendation generating device showing one or more modules, in accordance with some embodiments.

FIG. 3 depicts a Table including one or more application assessment parameters along with the associated criteria and weightage, in accordance some an embodiment

FIG. 4 depicts a Table including one or more business assessment parameters along with the associated criteria and weightage, in accordance an embodiment.

FIG. 5 depicts a Table including one or more risk assessment parameters along with the associated criteria and weightage, in accordance an embodiment.

FIG. 6 depicts a Table 600 including example application standard weightage score, business standard weightage score, and risk standard score for an existing legacy application and an existing monolith application, in accordance some embodiments.

FIG. 7 is a flowchart of a method of generating recommendations for enhancement of an existing application, in accordance with some embodiments.

FIG. 8 is a flowchart of a method of selecting one of the plurality of predefined recommendations for the existing application, in accordance with some embodiments.

FIG. 9 is a flowchart of a method of generating recommendations for enhancement of an existing legacy application, in accordance with some embodiments.

FIG. 10 depicts a Table including the application assessment parameters and the corresponding criteria and weightage for three existing legacy applications, in accordance with some exemplary embodiments.

FIG. 11 depicts a Table including the business assessment parameters and the corresponding criteria and weightage for the three existing applications, in accordance with some exemplary embodiments.

FIG. 12 depicts a Table including the risk assessment parameters and the corresponding criteria and weightage for the three existing applications, in accordance with some exemplary embodiments.

FIG. 13 is a flowchart of a method of generating recommendations for enhancement of an existing monolith application, in accordance with some embodiments.

FIG. 14 depicts a Table showing the application assessment parameters and the corresponding criteria and weightage for three existing monolith applications, in accordance with some exemplary embodiments.

FIG. 15 depicts a Table including the business assessment parameters and the corresponding criteria and weightage for the three existing monolith applications, in accordance with some exemplary embodiments.

FIG. 16 depicts a Table including the risk assessment parameters and the corresponding criteria and weightage for the three existing monolith applications, in accordance with some exemplary embodiments.

FIG. 17 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

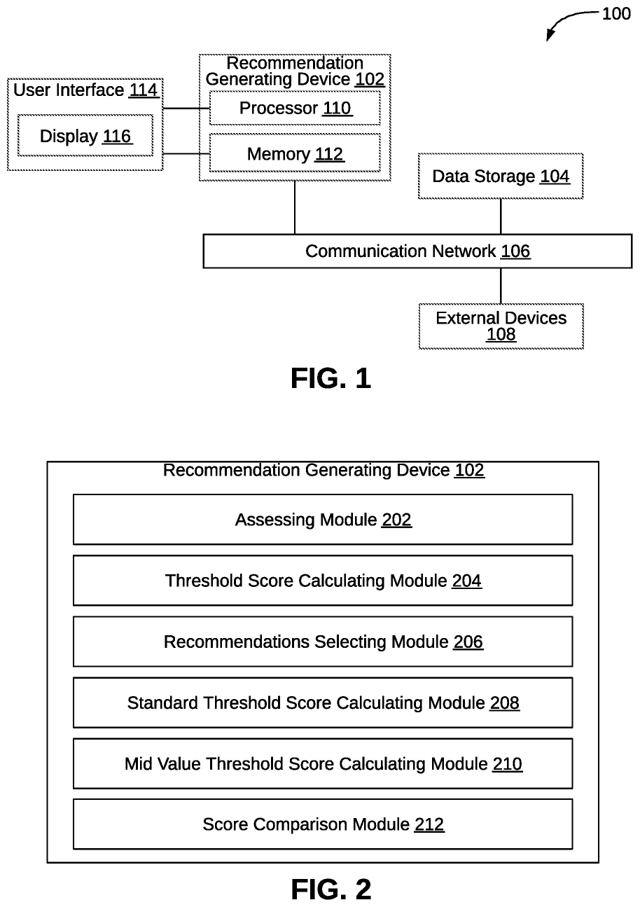

Referring now to FIG. 1, a block diagram of an exemplary system 100 for generating recommendations for enhancement of an existing application is illustrated, in accordance with some embodiments of the present disclosure. The system 100 may implement a recommendation generating device 102. Further, the system 100 may include a data storage 104. In some embodiments, the data storage 104 may store the existing application i.e. the data associated with the existing legacy or monolith application. The recommendation generating device 102 may be a computing device having data processing capability. In particular, the recommendation generating device 102 may have the capability for generating recommendations for enhancement of an existing application. Examples of the recommendation generating device 102 may include, but are not limited to a desktop, a laptop, a notebook, a netbook, a tablet, a smartphone, a mobile phone, an application server, a web server, or the like.

Additionally, the recommendation generating device 102 may be communicatively coupled to an external device 108 for sending and receiving various data. Examples of the external device 108 may include, but are not limited to, a remote server, digital devices, and a computer system. The recommendation generating device 102 may connect to the external device 108 over a communication network 106. The recommendation generating device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108.

The recommendation generating device 102 may be configured to perform one or more functionalities that may include assessing the existing application based on at least one of: one or more application assessment parameters, to determine an overall application assessment weightage score, one or more business assessment parameters, to determine an overall business assessment weightage score, and one or more risk-assessment parameters, to determine an overall risk-assessment weightage score. The one or more functionalities may further include calculating a legacy threshold (LT) score based on the overall application assessment weightage score, the overall business assessment weightage score, and the overall risk-assessment weightage score, and selecting one of a plurality of predefined recommendations for the existing application, based on the legacy threshold (LT).

To perform the above functionalities, the recommendation generating device 102 may include a processor 110 and a memory 112. The memory 112 may be communicatively coupled to the processor 110. The memory 112 may store a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the recommendation generating device 102.

Referring now to FIG. 2, a block diagram of the recommendation generating device 102 showing one or more modules is illustrated, in accordance with some embodiments. FIG. 2 is explained below with respect to a legacy application. In some embodiments, the recommendation generating device 102 may include an assessing module 202, a threshold score calculating module 204 (also, referred to as legacy threshold (LT) score calculating module 204), a recommendations selecting module 206, a standard threshold score calculating module 208 (also referred to as standard legacy threshold (SLT) score calculating module 208), a mid-value threshold score calculating module 210 (also referred to as mid-value legacy threshold (MVLT) score calculating module 210), and a score comparison module 212.

The assessing module 202 may assess each application, for example, a Brownfield application, based on three different perspectives of assessments, based on a set of parameters with respect to its corresponding criteria and weightage. The criteria may be derived automatically from multi-level analysis and data collections from the Brownfield applications. The criteria can be used directly or can be modified based on the application for further assessments. The assessing module 202 may assess each application based on one or more application assessment parameters, one or more business assessment parameters, and one or more risk-assessment parameters. In other words, the assessing module 202 may perform application assessment, business assessment, and risk assessment for each application. The Brownfield application on which the application assessment may be performed may be either a Legacy application or a Monolith application.

### Application Assessment

In some embodiments, the one or more application assessment parameters may include an existing application Lines of Code (LOC) parameter, an existing application usage or end users parameter, an availability of subject matter expert (SME) parameter, an application documentation existence parameter, a technology or framework skill set existence parameter, a technology or framework support in future parameter, a number of external systems involvement parameter, a database changes required parameter, an existing application stability parameter, an existing application complexity parameter, a flexibility in third party tool integration parameter, a new enhancement or module complexity parameter, a new enhancement or module estimated LOC parameter, a significant change in existing code base required parameter, a new enhancement or module relevance with existing modules parameter, and an existing code reusability parameter. The existing application may be assessed based on the one or more application assessment parameters, to determine an overall application assessment weightage score.

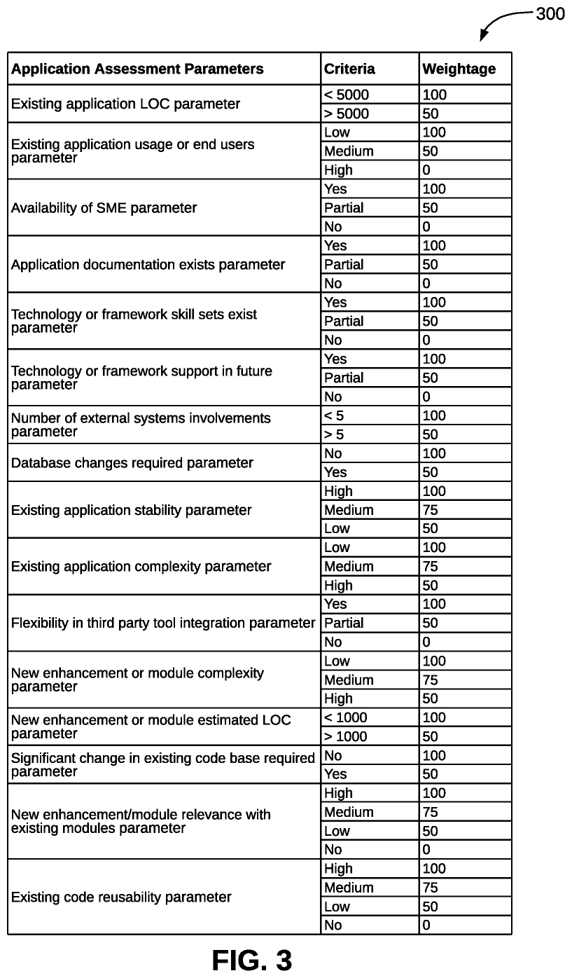

As such, there may be sixteen parameters identified for the application assessment in which each parameter may have a set of criteria and a corresponding weightage assigned to it. The criteria may be specific to that parameter derived automatically from multi-level analysis. Further, the criteria may be in the form of number with limit or Yes/Partial/No type or High/Medium/Low/No type. Each criterion may be assigned with a predefined weightage. For example, the predefined weightage value may be “100”, “75”, “50”, or “0” depending on the corresponding criteria. Higher value may denote positive or strong or good characteristic of the existing Brownfield application, whereas lower value may represent negative or weak or unstable characteristic of the Brownfield application. For example, if an application LOC is less than 5000, it may imply that the application is a compact application and scope of adding new features is high, and hence the weightage can be more. If the LOC is greater than 5000, it may imply that the application is heavy and scope of adding new feature is less. It may not imply that new features cannot be added if LOC is greater than 5000, however, the scope is defined based on criteria and weightage. FIG. 3 depicts a Table 300 including the one or more application assessment parameters along with the associated criteria and weightage. The one or more application assessment parameters along with their criteria and weightage are explained in detail below, in conjunction with the Table 300.

### Existing Application Lines of Code (LOC) Parameter

In the existing Brownfield application, Lines of Code (LOC) is an important parameter which determines the size and bulkiness of the application. For example, two criteria may be considered with the LOC—less than 5000 and greater than 5000 along with its corresponding weightage as 100 and 50, respectively.

### Existing Application Usage or End Users Parameter

If the existing Brownfield application usage or number of end users are less, then the scope of adding new implementations in the Brownfield application is more. For example, three criteria Low, Medium and High may be considered with their corresponding weightage as 100, 50 and 0, respectively.

### Availability of Subject Matter Expert (SME) Parameter

Assessment of the SME availability of the existing application can be used for taking decisions on new enhancements. For example, three criteria Yes, Partial and No may be considered with their corresponding weightage as 100, 50 and 0, respectively.

### Application Documentation Parameter

For any application, good and understandable documentation is must which helps to get the overall application knowledge. However, most legacy applications may not have well-structured document or the document itself may not exist. For example, three criteria Yes, Partial and No may be considered with their corresponding weightage as 100, 50 and 0, respectively.

### Technology or Framework Skill Set Existence Parameter

Availability of technology or framework skill sets existence parameter may represent the knowledge of the development team or business team on the technologies and framework used in the brownfield application. For example, three criteria Yes, Partial and No may be considered with their corresponding weightage as 100, 50 and 0, respectively.

### Technology or Framework Support Parameter

The technology or framework support parameter may represent support for the technology or framework used in the application in the future. All the toolsets, software, and framework used in the application might have some limitation in the support or the possibility of being upgraded or moved. Therefore, this parameter plays a major role in application assessment. For example, three criteria Yes, Partial and No may be considered with their corresponding weightage as 100, 50 and 0, respectively.

### Number of External Systems Parameter

If more external system calls exist, then the scope of adding new enhancements in the application might be less. For example, two criteria may be considered—less than 5 and greater than 5, along with their corresponding weightage as 100 and 50, respectively.

### Database Changes Parameter

If there are no database changes involved for new enhancement, then the scope of adding new implementations in the Brownfield application is more. For example, two criteria No and Yes may be considered with their corresponding weightage as 100 and 50, respectively.

### Existing Application Stability Parameter

If the stability of the application is high, then the scope of adding new implementations in the Brownfield application is more. For example, three criteria High, Medium and Low may be considered with their corresponding weightage as 100, 75 and 50, respectively.

### Existing Application Complexity Parameter

If the complexity of the application is low, then the scope of adding new implementations in the Brownfield application is more. For example, three criteria Low, Medium and High may be considered with their corresponding weightage as 100, 75 and 50, respectively.

### Flexibility in Third Party Tool Integration Parameter

If the existing application has the ability to support the integration with third party tools, then the scope of adding new implementations in the Brownfield application is more. For example, three criteria Yes, Partial and No may be considered with their corresponding weightage as 100, 50 and 0, respectively.

### New Enhancements or Modules Complexity Parameter

If the new functionalities complexity is less, then the scope of adding new implementations in the Brownfield application is more. For example, three criteria Low, Medium and High may be considered with their corresponding weightage as 100, 75 and 50, respectively.

### New Enhancement or Module Estimated LOC Parameter

If the new functionalities estimated LOC is less, then the scope of adding new implementations in the Brownfield application is more. For example, two criteria may be considered with LOC less than 1000 and greater than 1000 along with their corresponding weightage as 100 and 50, respectively.

### Significant Change in Existing Code Base Parameter

To support the new functionalities, if significant major changes are required in the existing code base, then the scope of adding new implementations in the Brownfield is less. For example, two criteria No and Yes may be considered with their corresponding weightage as 100 and 50, respectively.

New Enhancement or Module Relevance with Existing Modules Parameter

The New Enhancement or Module Relevance with Existing Modules Parameter represents the relevance or similarities of new features with existing functionalities, and may be derived based on multiple levels of analysis including: (a) process flow overlap and association, (b) data flow overlap and association in the processing, (c) user domain overlap and association, and (d) dependency of input and output of new enhancements with the existing application. For example, in a payment gateway functionality, the process of adding another bank is a new enhancement but the module similarity is very high. If the similarity is more, then the scope of adding new implementations in the Brownfield application is also more. For example, four criteria High, Medium, Low and No may be considered with their corresponding weightage as 100, 75, 50 and 0, respectively.

### Existing Code Reusability Parameter

If the existing code base reusability is more, then the scope of adding new implementations in the Brownfield application is also more. For example, four criteria High, Medium, Low and No may be considered with their corresponding weightage as 100, 75, 50 and 0, respectively.

### Business Assessment

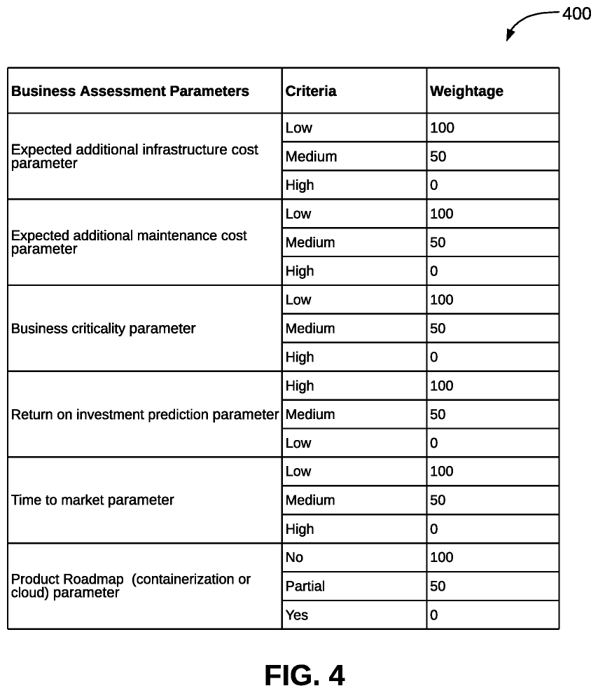

As mentioned above, the assessment module 202 may further perform business specific assessment (or simply, business assessment) on the existing Brownfield application that could either be a Legacy application or a Monolith application. The business assessment may be performed based on one or more business assessment parameters, to determine an overall business assessment weightage score. The one or more business assessment parameters may include an expected additional infrastructure cost parameter, an expected additional maintenance cost parameter, a business criticality parameter, a return-on-investment prediction parameter, a time to market parameter, and a product roadmap parameter. As such, six business assessment parameters may be identified for the business assessment. Each of these parameters may have a set of criteria and a corresponding weightage assigned to it. The criteria may be specific to that parameter. For example, the criteria may be in the form of Yes, Partial, or No. In another example, the criteria may be in the form of Low, Medium, or High. Each criterion is assigned with a predefined weightage which could be 100, 50, or 0 depending on the corresponding criteria. Higher value denotes a positive or strong or good characteristic of the existing Brownfield application related to business, whereas a lower value represents a negative or weak or unstable characteristic of the Brownfield applications. FIG. 4 depicts a Table 400 including the one or more business assessment parameters along with the associated criteria and weightage, in accordance an embodiment. The one or more business assessment parameters along with their criteria and weightage are explained in detail below, in conjunction with the Table 400.

### Expected Additional Infrastructure Cost Parameter

Infrastructure cost may get increased while adding new enhancements in the existing Brownfield application. But if it is less than or within the expected additional infrastructure cost, then the scope of adding new implementations in the Brownfield application is more. For example, three criteria Low, Medium, and High may be considered with their corresponding weightage as 100, 50 and 0, respectively.

### Expected Additional Maintenance Cost Parameter

Maintenance cost may increase while adding new enhancements in the existing Brownfield application. But if it less than or within the expected additional maintenance cost, then the scope of adding new implementations in the Brownfield application is more. For example, three criteria Low, Medium and High may be considered with their corresponding weightage as 100, 50 and 0, respectively.

### Business Criticality Parameter

The business criticality parameter represents the importance of business process in the existing Brownfield application. If it is low, then the scope of adding new implementations in the Brownfield application is more. For example, three criteria Low, Medium, and High may be considered with their corresponding weightage as 100, 50, and 0, respectively.

### Return on Investment Prediction Parameter

The return-on-investment prediction parameter relates to prediction of benefit or profit in terms of money based on the investment on new enhancements. For the existing Brownfield application, if the return-on-investment prediction is high, then the scope of adding new implementations in the Brownfield application is more. For example, three criteria High, Medium and Low may be considered with their corresponding weightage as 100, 50 and 0, respectively.

### Time to Market Parameter

If the time to market parameter is less, then the scope of adding new implementations in the Brownfield application is more. For example, three criteria Low, Medium, and High may be considered with their corresponding weightage as 100, 50 and 0, respectively.

### Product Roadmap

As per the business, if the product roadmap is expected to containerize the application or moving to cloud in the future, then the possibility of adding new enhancement in the Brownfield application is less. For example, three criteria No, Partial, and Yes may be considered with their corresponding weightage as 100, 50 and 0, respectively.

### Risk Assessment

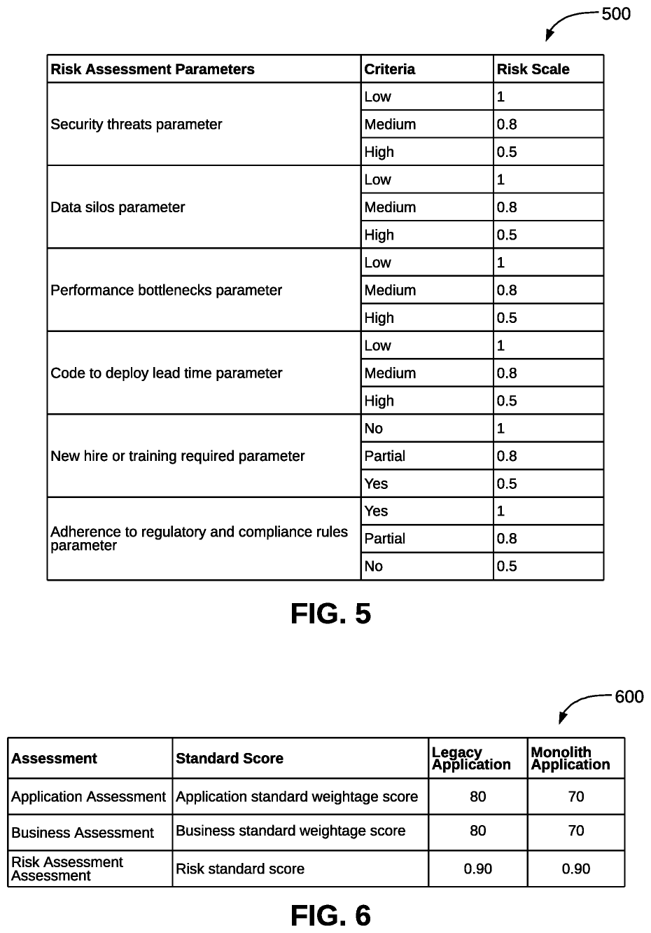

The assessment module 202 may further perform risk specific assessment on the existing Brownfield application, based on the one or more risk-assessment parameters, to determine an overall risk-assessment weightage score. The one or more risk assessment parameters may include a security threats parameter, a data silos parameter, a performance bottlenecks parameter, a code to deploy lead time parameter, a new hire or training required parameter, and an adherence to regulatory and compliance rules parameter. As such, six risk assessment parameters may be identified for risk assessment, such that each of these risk assessment parameters may have a set of criteria and a corresponding weightage assigned to it. The criteria may be specific to that parameter, and may be in the form of Low, Medium, or High. Alternately, the criteria may be in the form of Yes, Partial, or No. Each criterion may be assigned a predefined weightage which may be 1, 0.8, or 0.5, depending on the corresponding criteria. Higher values denote a positive, strength, or good characteristic of the existing Brownfield application, whereas lower values represent a negative, weak, or unstable characteristic of the Brownfield applications. FIG. 5 depicts a Table 500 including one or more risk assessment parameters along with the associated criteria and weightage, in accordance an embodiment. The one or more risk assessment parameters along with their criteria and weightage are explained in detail below, in conjunction with the Table 500.

### Security Threats Parameter

If the existing Brownfield application has less security related issues, then the scope of adding new implementations in the Brownfield application is more. For example, three criteria of Low, Medium, and High may be considered with their corresponding weightage as 1, 0.8, and 0.5, respectively.

### Data Silos Parameter

The data silos parameter represents database inconsistencies and inaccurate data. If the existing Brownfield application has less data silos related issues, then the scope of adding new implementations in the Brownfield application is more. For example, three criteria of Low, Medium, and High may be considered with their corresponding weightage as 1, 0.8, and 0.5, respectively.

### Performance Bottlenecks Parameter

If the existing Brownfield application has less performance related issues, then the scope of adding new implementations in the Brownfield application is more. For example, three criteria may be considered of Low, Medium and High, with their corresponding weightage as 1, 0.8, and 0.5, respectively.

### Code to Deploy Lead Time Parameter

If the existing Brownfield application has less lead time for every release cycle, then the scope of adding new implementations in the Brownfield application is more. For example, three criteria of Low, Medium, and High may be considered with their corresponding weightage as 1, 0.8, and 0.5, respectively.

### New Hire or Training Required Parameter

For developing new enhancements and understanding existing Brownfield applications, new hiring and training might be required which involves cost. If it is required, then the scope of adding new implementations in the Brownfield application is less. For example, three criteria of No, Partial, and Yes may be considered with their corresponding weightage as 1, 0.8, and 0.5, respectively.

### Adherence to Regulatory and Compliance Rules Parameter

Some workloads might be critical to maintain compliance requirements. These include data protection, data privacy, etc. If the existing Brownfield application has adherence to all the compliance and regulatory rules, then the scope of adding new enhancements is more. For example, three criteria of Yes, Partial, and No may be considered with their corresponding weightage as 1, 0.8, and 0.5, respectively.

As mentioned above, a criteria and a weightage is associated with the each of the one or more application assessment parameters, the one or more business assessment parameters, and the one or more risk-assessment parameters. A combination of all the above parameters with their associated weightage is analyzed. The impact of each parameter's weightage may be used to find a threshold level which may then help to generate recommendations of the best option for the enhancement of the Brownfield application. In each assessment (i.e., the application assessment, the business assessment, and the risk-assessment), a set of predefined values may be considered as a standard value for the criteria.

An application standard weightage score, a business standard weightage score, and a risk standard score may be considered as a predefined value for calculating a standard Legacy Threshold (LT) score. Example application standard weightage score, business standard weightage score, and risk standard score for an existing legacy application and an existing monolith application are depicted in Table 600, as shown in FIG. 6. As shown in the Table 600, by way of an example, for the existing legacy application, the application standard weightage score, the business standard weightage score, and the risk standard score of 80, 80, and 0.90, respectively may be considered. For the existing monolith application, the application standard weightage score, the business standard weightage score, and the risk standard score of 70, 70, and 0.90, respectively may be considered.

Referring back to FIG. 2, the legacy threshold (LT) score calculating module 204 may calculate a legacy threshold (LT) score based on the overall application assessment weightage score, the overall business assessment weightage score, and the overall risk-assessment weightage score.

Once the application assessment, the business assessment, and the risk assessment is performed and the weightage for each criterion associated with the parameters is applied, a total weightage may be calculated for each assessment. As such, an application total weightage (TW1), a business total weightage (TW2), and a total risk scale (TRS) may be calculated for the application assessment, the business assessment, and the risk assessment, respectively.

The application total weightage (TW1) is sum of weightage applied against each of the one or more (i.e. sixteen) application assessment parameters, i.e. the application total weightage (TW1)=first application assessment parameter*weightage+second application assessment parameter*weightage+ . . . sixteenth application assessment parameter*weightage.

Further, an application weightage score (WS1) may be calculated for the application assessment, as:

$$Application weightage score ( WS 1 ) = Application total weightage ( TW 1 ) / number of application assessment parameters$$

In other words, WS1=TW1/16

The business total weightage (TW2) is sum of weightage applied against each of the one or more (i.e. six) business assessment parameters, i.e. the business total weightage (TW2)=first business assessment parameter*weightage+second business assessment parameter*weightage+ . . . sixth business assessment parameter*weightage.

A business weightage score (WS2) may be calculated for the business assessment, as:

$$Business weightage score ( WS 2 ) = Business total weightage ( TW 2 ) / number of business assessment parameters$$

In other words, WS2=TW2/6

The total risk scale (TRS) is sum of risks scale applied against each of the one or more (i.e. six) risk assessment parameters, i.e. the total risk scale (TRS)=first risk assessment parameter*risk scale+second risk assessment parameter*risk scale+ . . . sixth risk assessment parameter*risk scale.

A risk weightage score may be calculated for the risk assessment, as:

$$Risk weightage score ( RS ) = total risk scale ( TRS ) / number of risk assessment parameters$$

In other words, RS=TRS/6

A standard legacy threshold (SLT) score may be calculated. To this end, in some embodiments, the standard legacy threshold (SLT) score calculating module 208 may be configured to calculate the standard legacy threshold (SLT) score based on the predefined application standard weightage score, the predefined business standard weightage score, and the predefined risk standard score (depicted in FIG. 6), as below:

$$Standard Legacy Threshold ( SLT ) = ( ( predefined application standard weightage score + predefined business standard weightage score ) / 2 ) * ( predefined risk standard score )$$

Therefore, in accordance with the example predefined application standard weightage score, the predefined business standard weightage score, and the predefined risk standard score depicted in FIG. 6, the SLT may be calculated as:

$$S LT = ( ( 80 + 80 ) / 2 ) * 0.9 = 72$$

The mid-value legacy threshold (MVLT) score calculating module 210 may calculate a mid-value legacy threshold (MVLT) score, based on the standard legacy threshold (SLT), as:

mid-value legacy threshold (MVLT)=standard legacy threshold (SLT)−(standard legacy threshold (SLT)/3)

Therefore, in accordance with the SLT as calculated above, the mid-value legacy threshold (MVLT) may be calculated as:

$$MVLT = 72 - ( 72 / 3 ) = 72 - 24 = 48$$

The legacy threshold (LT) score calculating module 204 may calculate the legacy threshold (LT) score using the application weightage score (WS1), the business weightage score (WS2), and the risk weightage score (RS), as calculated above, and as below:

$$Legacy threshold ( LT ) = ( ( ( application weightage score ( WS 1 ) + ( business weightage score ( WS 2 ) ) ) / 2 ) * Risk weightage Score ( RS )$$

The recommendation selecting module 206 may select one of a plurality of predefined recommendations for the existing application, based on the legacy threshold (LT). In particular, the score comparison module 212 may compare the existing application's legacy threshold (LT) score with the standard legacy threshold (SLT) score and the mid-value legacy threshold (MVLT) score, in order to identify the recommendation options. The recommendation selecting module 206 may therefore select one of a plurality of predefined recommendations for the existing application, based on the comparison. For example, the plurality of predefined recommendations for the existing application may include (i) developing a new enhancement within the existing application recommendation, (ii) developing a new enhancement as a separate new application dependent on the existing application and establishing communication or integration between the new application and the existing application recommendation, and (iii) developing a new enhancement as a complete independent application recommendation.

In some embodiments, the recommendation selecting module 206 may select the developing a new enhancement within the existing application recommendation, when the legacy threshold (LT) score is greater than or equal to the standard legacy threshold (SLT) score. The recommendation selecting module 206 may select the developing a new enhancement as a separate new application dependent on the existing application and establishing communication or integration between the new application and the existing application recommendation, when the legacy threshold (LT) score is less than the standard legacy threshold (SLT) score and greater than the mid-value legacy threshold (MVLT) score. The recommendation selecting module 206 may select the developing a new enhancement as a complete independent application recommendation, when the legacy threshold (LT) score is less than or equal to the mid-value legacy threshold (MVLT) score.

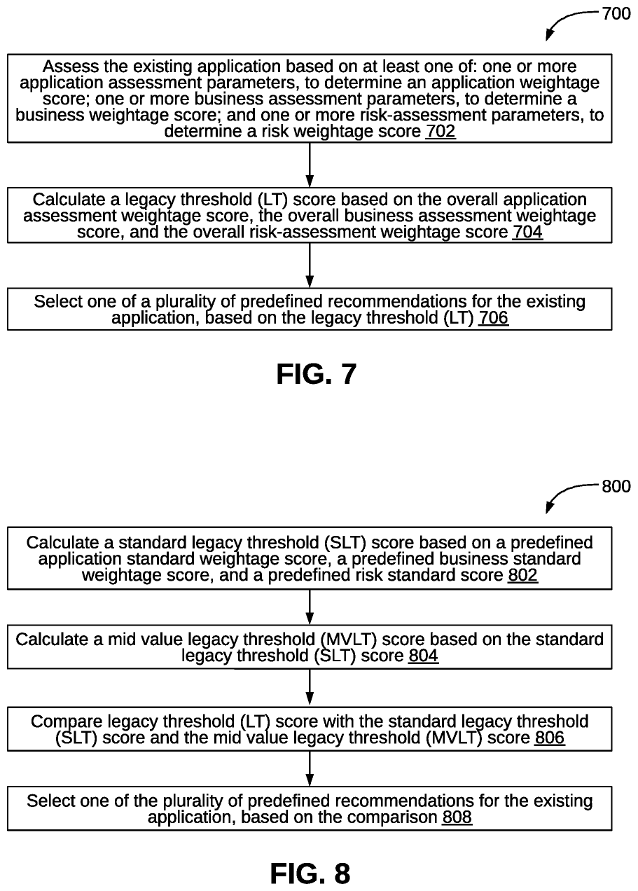

Referring now to FIG. 7, a flowchart of a method 700 of generating recommendations for enhancement of an existing application is illustrated, in accordance with some embodiments. The method may be performed by the recommendation generating device 102.

At step 702, the existing application may be assessed based on at least one of: the one or more application assessment parameters to determine an application weightage score, the one or more business assessment parameters to determine a business weightage score, and one or more risk-assessment parameters to determine a risk weightage score. By way of an example, the one or more application assessment parameters may include sixteen application assessment parameters—an existing application Lines of Code (LOC) parameter, an existing application usage or end users parameter, an availability of subject matter expert (SME) parameter, an application documentation existence parameter, a technology or framework skill set existence parameter, a technology or framework support in future parameter, a number of external systems involvement parameter, a database changes required parameter, an existing application stability parameter, an existing application complexity parameter, a flexibility in third party tool integration parameter, a new enhancement or module complexity parameter, a new enhancement or module estimated LOC parameter, a significant change in existing code base required parameter, a new enhancement or module relevance with existing modules parameter, and an existing code reusability parameter. In some embodiments, determining the application weightage score may include assigning an application assessment parameter score corresponding to each of the one or more application assessment parameters, based on an associated predefined criteria and weightage, and averaging one or more application assessment parameter scores corresponding to the one or more application assessment parameters, to obtain the application weightage score.

The one or more business assessment parameters may include six business assessment parameters—an expected additional infrastructure cost parameter, an expected additional maintenance cost parameter, a business criticality parameter, a return-on-investment prediction parameter, a time to market parameter, and a product roadmap parameter. In some embodiments, determining the business weightage score may include assigning a business assessment parameter score corresponding to each of the one or more business assessment parameters, based on an associated predefined criteria and weightage, and averaging one or more business assessment parameter scores corresponding to the one or more business assessment parameters, to obtain the business weightage score.

The one or more risk assessment parameters may include six risk assessment parameters—a security threats parameter, a data silos parameter, a performance bottlenecks parameter, a code to deploy lead time parameter, a new hire or training required parameter, and an adherence to regulatory and compliance rules parameter. In some embodiments, determining the risk weightage score may include assigning a risk-assessment parameter score corresponding to each of the one or more risk-assessment parameters, based on an associated predefined criteria and weightage, and averaging one or more risk-assessment parameter scores corresponding to the one or more risk-assessment parameters, to obtain the risk weightage score.

At step 704, a threshold score may be calculated based on the application weightage score, the business weightage score, and the risk weightage score. At step 706, one of a plurality of predefined recommendations for the existing application may be selected, based on the threshold score. In some embodiments, the plurality of predefined recommendations for the existing application may include (i) developing a new enhancement within the existing application recommendation, (ii) developing a new enhancement as a separate new application dependent on the existing application and establishing communication or integration between the new application and the existing application recommendation, and (iii) developing a new enhancement as a complete independent application recommendation. The step 706 is explained in detail in conjunction with FIG. 8.

Referring now to FIG. 8, a flowchart of a method 800 of selecting one of the plurality of predefined recommendations for the existing application is illustrated, in accordance with some embodiments. At step 802, a standard threshold score may be determined based on a predefined application standard weightage score, a predefined business standard weightage score, and a predefined risk standard score. At step 804, a mid-value threshold score may be calculated based on the standard threshold score. At step 806, the threshold score may be compared with the standard threshold score and the mid-value threshold score.

At step 808, one of the plurality of predefined recommendations for the existing application may be selected, based on the comparison. For example, the ‘developing a new enhancement within the existing application’ recommendation may be selected, when the threshold score is greater than or equal to the standard threshold score. The ‘developing a new enhancement as a separate new application dependent on the existing application and establishing communication or integration between the new application and the existing application’ recommendation may be selected, when the threshold score is less than the standard threshold score and greater than the mid-value threshold score. The ‘developing a new enhancement as a complete independent application’ recommendation may be selected, when the threshold score is less than or equal to the mid-value threshold score.

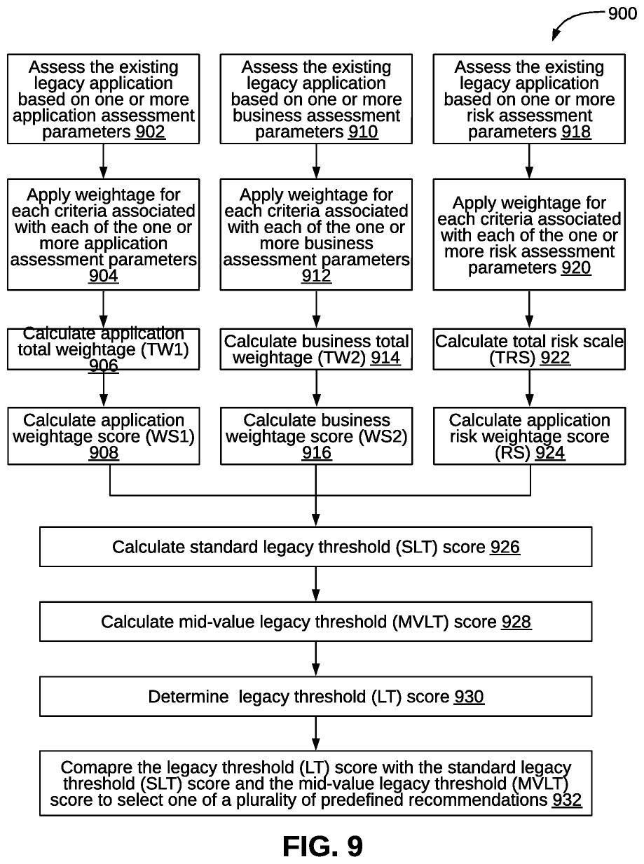

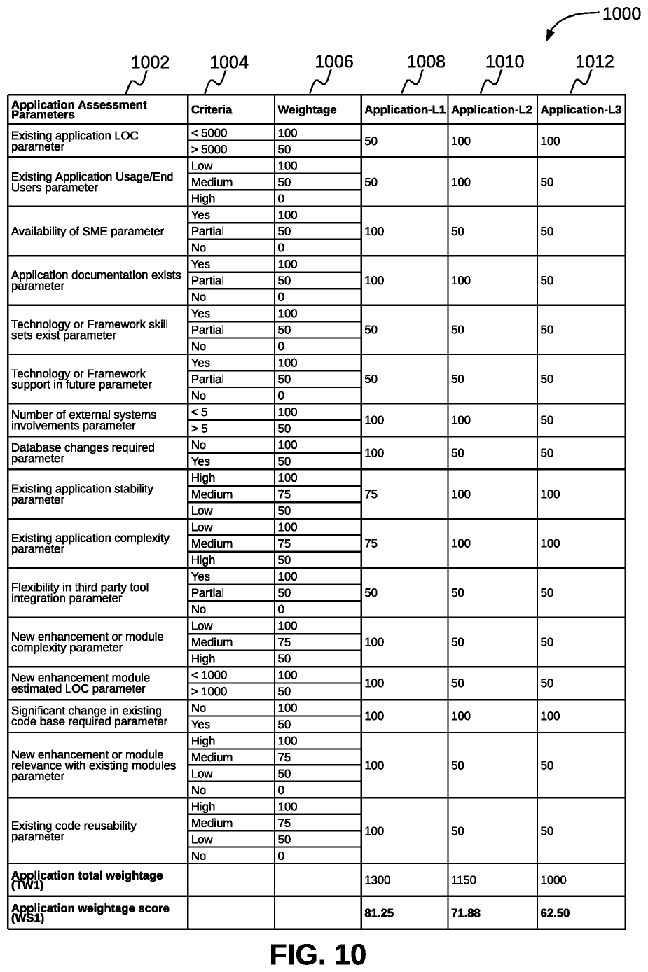

As mentioned above, the existing application may be a legacy application or a monolith application. Referring now to FIG. 9, a flowchart of a method 900 of generating recommendations for enhancement of an existing legacy application is illustrated, in accordance with some embodiments. The method 900 is explained in conjunction with FIGS. 10-12.

At step 902, application assessment is performed for the legacy application based on the one or more application assessment parameters along with the respective criteria. For example, the legacy application is assessed with respect to sixteen application assessment parameters, as described in FIG. 3. Each criterion may have a predefined weightage.

At step 904, the weightage may be applied for each criteria associated with each of the one or more application assessment parameters. At step 906, an application total weightage (TW1) may be calculated. To this end, an application assessment parameter score corresponding to each of the one or more application assessment parameters is assigned, based on an associated predefined criteria and weightage. As such, an application total weightage (TW1) is obtained as a sum of application assessment parameter scores with weightage applied, for each of the sixteen application assessment parameters, as follows:

$$Application total weightage ( TW 1 ) = parameter - 1 score * weightage + parameter - 2 score * weightage + … parameter - 16 score * weightage$$

At step 908, the one or more application assessment parameter scores corresponding to the one or more application assessment parameters are averaged, to obtain the application weightage score (WS1) for the application assessment, as shown below:

$$Application weightage score ( WS 1 ) = application total weightage ( TW 1 ) / number of application assessment parameters$$

In other words, WS1=TW1/16

By way of an example, three existing legacy applications—Application-L1, Application-L2, and Application-L3 may be considered. As such, each of the three existing legacy applications are assessed against the one or more application assessment parameters, the one or more business assessment parameters, and the one or more risk-assessment parameters.

The three existing legacy applications Application-L1, Application-L2, and Application-L3 are assessed against the sixteen application assessment parameters and an application assessment parameter score corresponding to each of the sixteen application assessment parameters is obtained, based on an associated predefined criteria and weightage. FIG. 10 illustrates a Table 1000 showing the sixteen application assessment parameters and the corresponding criteria and weightage for the three existing legacy applications—Application-L1, Application-L2, and Application-L3, in accordance with an exemplary embodiment. As shown in Table 1000, column 1002 includes the sixteen application assessment parameters, column 1004 includes a criteria, column 1006 includes a weightage corresponding to each criteria, column 1008 includes an application assessment parameter score corresponding to each of the one or more application assessment parameters for the Application-L1, assigned based on the criteria and the weightage, column 1010 includes an application assessment parameter score corresponding to each of the one or more application assessment parameters for the Application-L2, assigned based on the criteria and the weightage, and column 1012 includes an application assessment parameter score corresponding to each of the one or more application assessment parameters for the Application-L3, assigned based on the criteria and the weightage. The Table 1000 further shows an application total weightage (TW1) for the Application-L1, Application-L2, and Application-L3, i.e. 1300, 1150, and 1000, respectively. Further, the Table 1000 shows an application weightage score (WS1) for the Application-L1, Application-L2, and Application-L3, i.e. 81.25 (i.e. 1300/16), 71.88 (1150/16), and 62.50 (1000/16), respectively.

Referring back to FIG. 9, at step, 910, business assessment is performed for the legacy application based on the one or more business assessment parameters along with the respective criteria. For example, the legacy application is assessed with respect to six business parameters, as described in FIG. 4. Each criterion may have a predefined weightage.

At step 912, the weightage may be applied for each criterion associated with the each of the one or more business assessment parameters. At step 914, a business weightage score may be calculated. To this end, a business assessment parameter score corresponding to each of the one or more business assessment parameters is assigned, based on an associated predefined criteria and weightage. As such, a business total weightage (TW2) is obtained as a sum of business assessment parameter scores with weightage applied, for each of the six business assessment parameters, as follows:

$$Business total weightage ( TW 1 ) = parameter - 1 score * weightage + parameter - 2 score * weightage + … parameter - 6 score * weightage$$

At step 916, the one or more business assessment parameter scores corresponding to the one or more business assessment parameters are averaged, to obtain the business weightage score (WS2) for the business assessment, as shown below:

$$Business weightage score ( WS 2 ) = business total weightage ( TW 2 ) / number of business assessment parameters$$

In other words, WS2=TW2/6

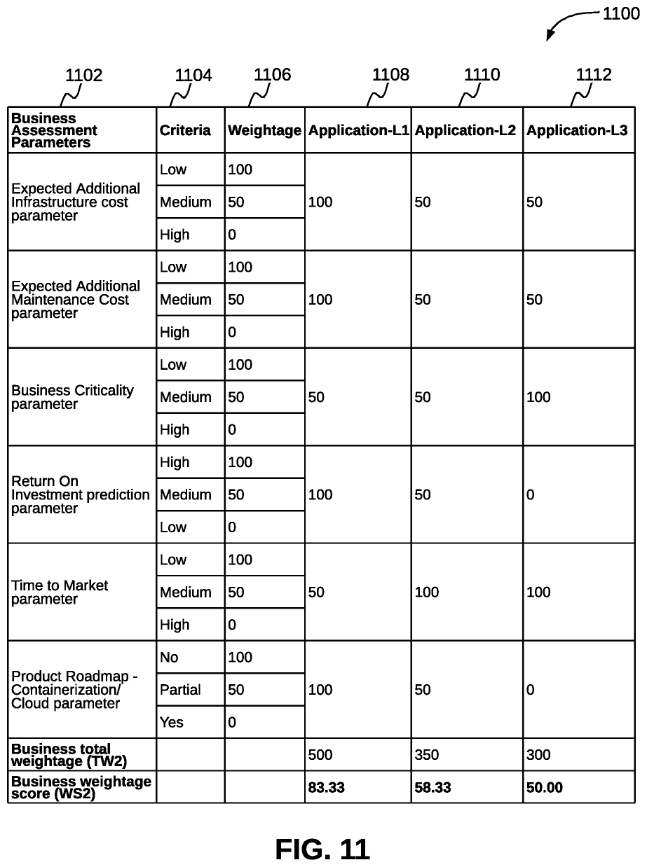

FIG. 11 illustrates a Table 1100 showing the six business assessment parameters and the corresponding criteria and weightage for the three existing legacy applications—Application-L1, Application-L2, and Application-L3, in accordance with some exemplary embodiments. As shown in Table 1100, column 1102 includes the six business assessment parameters, column 1104 includes a criteria, column 1106 includes a weightage corresponding to each criteria, column 1108 includes an business assessment parameter score corresponding to each of the six business assessment parameters for the Application-L1, assigned based on the criteria and the weightage, column 1110 includes a business assessment parameter score corresponding to each of the six business assessment parameters for the Application-L2, assigned based on the criteria and the weightage, and column 1112 includes an business assessment parameter score corresponding to each of the six business assessment parameters for the Application-L3, assigned based on the criteria and the weightage. The Table 1100 further shows a business total weightage (TW2) for the Application-L1, Application-L2, and Application-L3, i.e. 500, 350, and 300, respectively. Further, the Table 1100 shows a business weightage score (WS2) for the Application-L1, Application-L2, and Application-L3, i.e. 83.33 (i.e. 500/6), 58.33 (350/6), and 50.00 (300/6), respectively.

Referring again to FIG. 9, at step, 918, risk assessment is performed for the legacy application based on the one or more risk assessment parameters along with the respective criteria. For example, the legacy application is assessed with respect to six risk parameters, as described in FIG. 5. Each criterion may have a predefined weightage (or risk scale).

At step 920, the weightage (risk scale) may be applied for each criterion associated with the each of the one or more risk assessment parameters. At step 922, a risk weightage score (RS) may be calculated. To this end, a risk assessment parameter score corresponding to each of the one or more risk assessment parameters is assigned, based on an associated predefined criteria and weightage. As such, a total risk scale (TRS) is obtained as a sum of risk-assessment parameter scores with weightage applied, for each of the six risk assessment parameters, as follows:

$$Total risk scale ( TRS ) = parameter - 1 score * weightage + parameter - 2 score * weightage + … . parameter - 6 score * weightage$$

At step 924, the one or more risk assessment parameter scores corresponding to the one or more risk assessment parameters are averaged, to obtain the risk weightage score (RS) for the risk assessment, as shown below:

$$Risk weightage score ( RS ) = risk weighted score ( RS ) / number of risk assessment parameters$$

In other words, RS=TRS/6

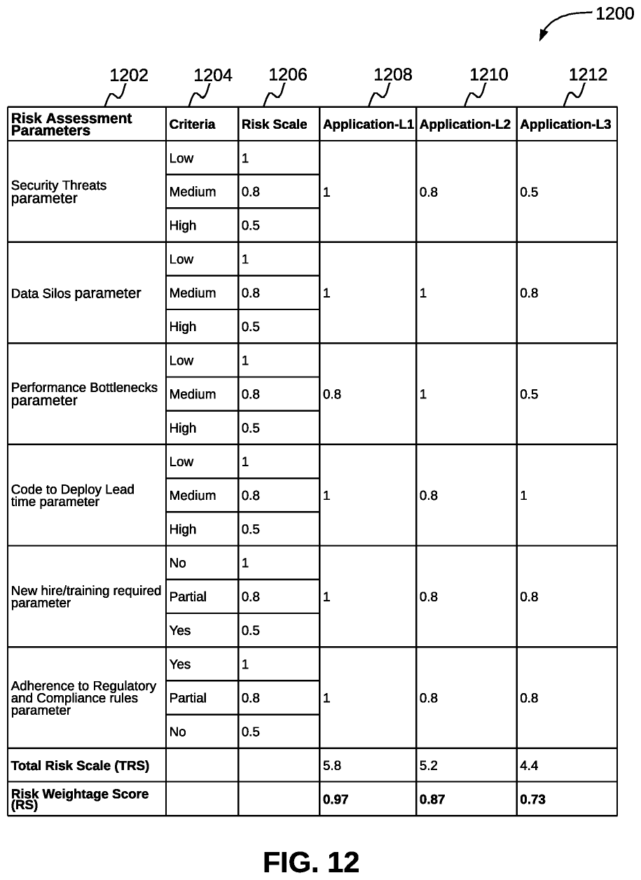

FIG. 12 illustrates a Table 1200 showing the six risk assessment parameters and the corresponding criteria and weightage for the three existing legacy applications—Application-L1, Application-L2, and Application-L3, in accordance with some exemplary embodiments. As shown in Table 1200, column 1202 includes the six risk assessment parameters, column 1204 includes a criteria, column 1206 includes a weightage corresponding to each criteria, column 1208 includes an risk assessment parameter score corresponding to each of the six risk assessment parameters for the Application-L1, assigned based on the criteria and the weightage, column 1210 includes a risk assessment parameter score corresponding to each of the six risk assessment parameters for the Application-L2, assigned based on the criteria and the weightage, and column 1212 includes a risk assessment parameter score corresponding to each of the six risk assessment parameters for the Application-L3, assigned based on the criteria and the weightage. The Table 1200 further shows a total risk scale (TRS) for the Application-L1, Application-L2, and Application-L3, i.e. 5.8, 5.2, and 4.4, respectively. Further, the Table 1200 shows a risk weightage score (RS) for the Application-L1, Application-L2, and Application-L3, i.e. 0.97 (i.e. 5.8/6), 0.87 (5.2/6), and 0.73 (4.4/6), respectively.

Referring to FIG. 9, at step 926, a standard legacy threshold (SLT) score (corresponding to the standard threshold score) is determined based on a predefined application standard weightage score, a predefined business standard weightage score, and a predefined risk standard score, as follows:

$$Standard Legacy Threshold ( SLT ) = ( ( predefined application standard \\ weightage score + predefined business standard \\ weightage score ) / 2 ) * predefined risk standard score$$

For the legacy application, the predefined application standard weightage score (80), the predefined business standard weightage score (80), and the predefined risk standard score (0.90) is depicted in the Table 600, as shown in FIG. 6. Therefore, for Application-L1, the Application-L2, and Application-L3,

$$SLT = ( ( 80 + 80 ) / 2 ) * 0.9 = 72$$

At step 928, a mid-value legacy threshold (MVLT) score (corresponding to the mid-value threshold score) is determined based on the standard legacy threshold (SLT), as follows:

$$Mid - value legacy threshold ( MVLT ) score = standard legacy threshold ( SLT ) score - ( standard legacy threshold ( SLT ) / 3 )$$

Therefore, for Application-L1, the Application-L2, and Application-L3,

$$MVLT = 72 - ( 72 / 3 ) = 72 - 24 = 48$$

At step 930, a legacy threshold (LT) score is determined based on the application weightage score (WS1), the business weightage score (WS2), and the risk weightage score (RS), as follows:

$$Legacy Threshold ( LT ) = ( ( WS 1 + WS 2 ) / 2 ) * RS$$

As such, for Application-L1,

$$LT = ( ( 81.25 + 83.33 ) / 2 ) * 0.97 = 82.29 * 0.97 = 79.82$$

For Application-L2,

$$LT = ( ( 71.88 + 58.33 ) / 2 ) * 0.87 = 65.11 * 0.87 = 56.65$$

For Application-L3,

$$LT = ( ( 62.5 + 50 ) / 2 ) * 0.73 = 56.25 * 0.73 = 41.06$$

At step 932, the legacy threshold (LT) score is compared with the standard legacy threshold (SLT) score and the mid-value legacy threshold (MVLT) score to identify the recommendation options. One of the plurality of predefined recommendations for the existing application is selected, based on the comparison. For example, (i) developing a new enhancement within the existing application recommendation is selected, when the legacy threshold (LT) score is greater than or equal to the standard legacy threshold (SLT) score; (ii) developing a new enhancement as a separate new application dependent on the existing application and establishing communication or integration between the new application and the existing application recommendation is selected, when the legacy threshold (LT) score is less than the standard legacy threshold (SLT) score and greater than the mid-value legacy threshold (MVLT) score; and (iii) developing a new enhancement as a complete independent application recommendation is selected, when the legacy threshold (LT) score is less than or equal to the mid-value legacy threshold (MVLT) score.

Accordingly, for the Application-L1,

$$LT ( 79.82 ) > SLT ( 72 )$$

Therefore, for Application-1, (i) developing a new enhancement within the existing application recommendation is selected.

For the Application-L2,

$$MVLT ( 48 ) < LT ( 56.65 ) < SLT ( 72 )$$

Therefore, for Application-2, (ii) developing a new enhancement as a separate new application dependent on the existing application and establishing communication or integration between the new application and the existing application recommendation is selected.

For the Application-L3,

$$LT ( 41.06 ) <= MVLT ( 48 )$$

Therefore, for Application-3, (iii) developing a new enhancement as a complete independent application recommendation is selected.

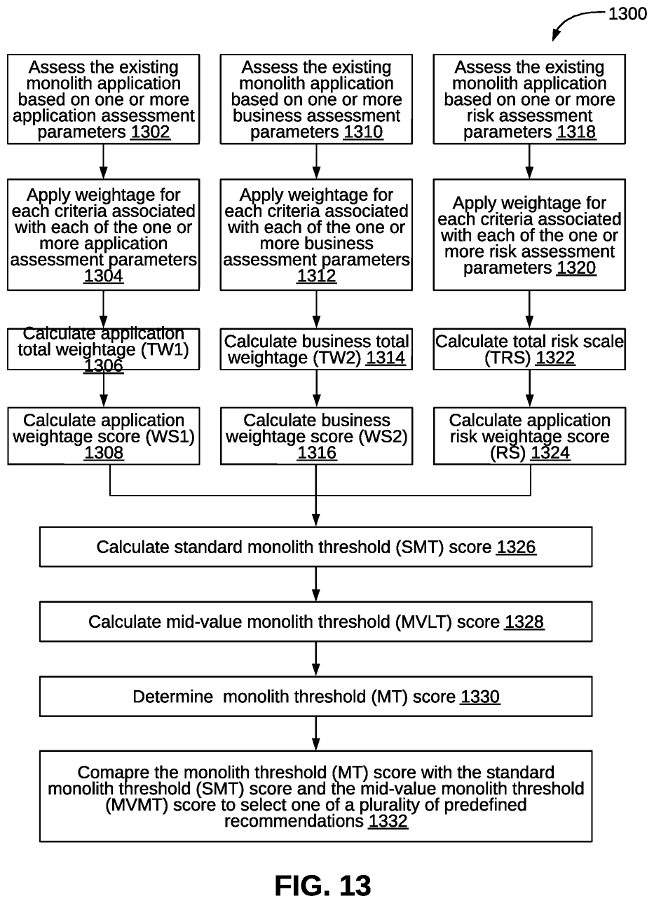

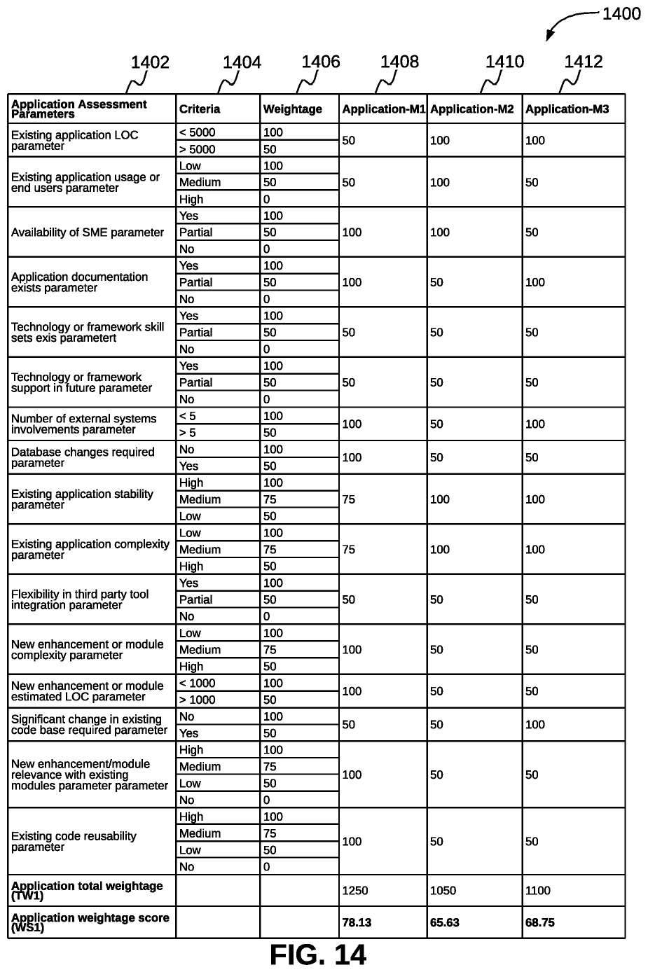

Referring now to FIG. 13, a flowchart of a method 1300 of generating recommendations for enhancement of an existing monolith application is illustrated, in accordance with some embodiments. The method 1300 is explained in conjunction with FIGS. 14-16.

At step 1302, application assessment is performed for the monolith application based on the one or more application assessment parameters along with the respective criteria. For example, the monolith application is assessed with respect to sixteen application assessment parameters, as described in FIG. 3. Each criterion may have a predefined weightage.

At step 1304, the weightage may be applied for each criteria associated with each of the one or more application assessment parameters. At step 1306, an application total weightage (TW1) may be calculated, as explained in method 900. As such, an application total weightage (TW1) is obtained as a sum of application assessment parameter scores with weightage applied, for each of the sixteen application assessment parameters, as follows:

$$Application total weightage ( TW 1 ) = parameter - 1 * weightage + parameter - 2 score * weightage + … . paremeter - 16 score * weightage$$

At step 1308, the one or more application assessment parameter scores corresponding to the one or more application assessment parameters are averaged, to obtain the application weightage score (WS1) for the application assessment, as shown below:

$$Application weightage score ( WS 1 ) = application total \\ weightage ( TW 1 ) / number of application assessment parameters$$

In other words, WS1=TW1/16

By way of an example, three existing monolith applications—Application-M1, Application-M2, and Application-M3 may be considered. As such, each of the three existing monolith applications are assessed against the one or more application assessment parameters, the one or more business assessment parameters, and the one or more risk-assessment parameters.

The three existing monolith applications Application-M1, Application-M2, and Application-M3 are assessed against the sixteen application assessment parameters and an application assessment parameter score corresponding to each of the sixteen application assessment parameters is obtained, based on an associated predefined criteria and weightage. FIG. 14 illustrates a Table 1400 showing the sixteen application assessment parameters and the corresponding criteria and weightage for the three existing monolith applications—Application-M1, Application-M2, and Application-M3, in accordance with an exemplary embodiment. As shown in Table 1400, column 1402 includes the sixteen application assessment parameters, column 1404 includes a criteria, column 1406 includes a weightage corresponding to each criteria, column 1408 includes an application assessment parameter score corresponding to each of the one or more application assessment parameters for the Application-M1, assigned based on the criteria and the weightage, column 1410 includes an application assessment parameter score corresponding to each of the one or more application assessment parameters for the Application-M2, assigned based on the criteria and the weightage, and column 1412 includes an application assessment parameter score corresponding to each of the one or more application assessment parameters for the Application-M3, assigned based on the criteria and the weightage. The Table 1400 further shows an application total weightage (TW1) for the Application-M1, Application-M2, and Application-M3, i.e. 1250, 1050, and 1100, respectively. Further, the Table 1400 shows an application weightage score (WS1) for the Application-M1, Application-M2, and Application-M3, i.e. 78.13, 65.63, and 68.75, respectively.

Referring back to FIG. 13, at step, 1310, business assessment is performed for the monolith application based on the one or more business assessment parameters along with the respective criteria. For example, the monolith application is assessed with respect to six business parameters, as described in FIG. 4. Each criterion may have a predefined weightage.

At step 1312, the weightage may be applied for each criterion associated with the each of the one or more business assessment parameters. At step 1314, a business weightage score may be calculated. To this end, a business assessment parameter score corresponding to each of the one or more business assessment parameters is assigned, based on an associated predefined criteria and weightage. As such, a business total weightage (TW2) is obtained as a sum of business assessment parameter scores with weightage applied, for each of the six business assessment parameters, as follows:

$$Business total weightage ( TW 1 ) = parameter - 1 score * weightage + parameter - 2 score * weightage + … . parameter - 6 score * weightage$$

At step 1316, the one or more business assessment parameter scores corresponding to the one or more business assessment parameters are averaged, to obtain the business weightage score (WS2) for the business assessment, as shown below:

$$Business weightage score ( WS 2 ) = business total weightage \\ ( TW 2 ) / number of business assessment parameters$$

In other words, WS2=TW2/6

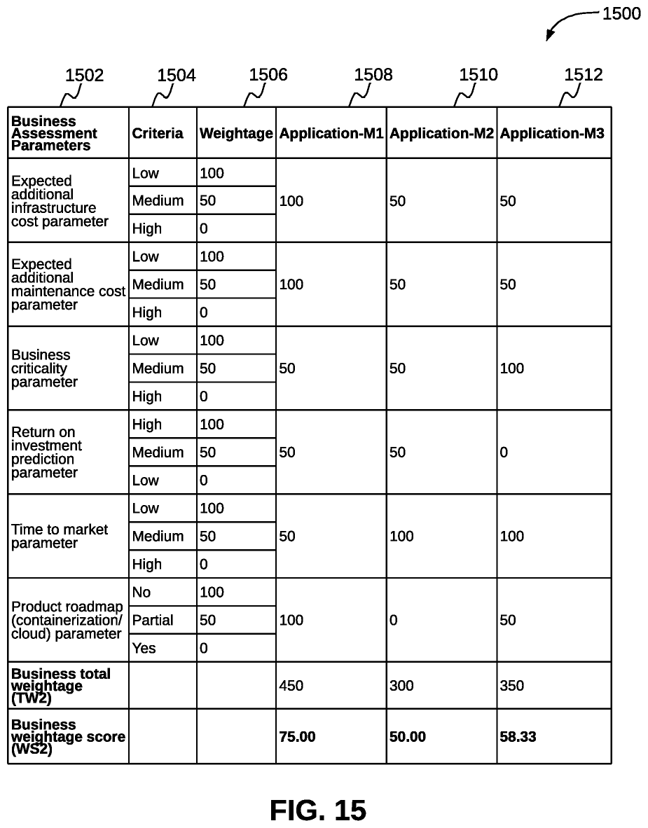

FIG. 15 illustrates a Table 1500 showing the six business assessment parameters and the corresponding criteria and weightage for the three existing applications—Application-M1, Application-M2, and Application-M3, in accordance with some an exemplary embodiment. As shown in Table 1500, column 1502 includes the six business assessment parameters, column 1504 includes a criteria, column 1506 includes a weightage corresponding to each criteria, column 1508 includes an business assessment parameter score corresponding to each of the six business assessment parameters for the Application-M1, assigned based on the criteria and the weightage, column 1510 includes a business assessment parameter score corresponding to each of the six business assessment parameters for the Application-M2, assigned based on the criteria and the weightage, and column 1512 includes an business assessment parameter score corresponding to each of the six business assessment parameters for the Application-M3, assigned based on the criteria and the weightage. The Table 1500 further shows a business total weightage (TW2) for the Application-M1, Application-M2, and Application-M3, i.e. 450, 300, and 350, respectively. Further, the Table 1500 shows a business weightage score (WS2) for the Application-M1, Application-M2, and Application-M3, i.e. 75.00, 50.00, and 58.33, respectively.

Referring again to FIG. 13, at step, 1318, risk assessment is performed for the monolith application based on the one or more risk assessment parameters along with the respective criteria. For example, the monolith application is assessed with respect to six risk parameters, as described in FIG. 5. Each criterion may have a predefined weightage (or risk scale).

At step 1320, the weightage (risk scale) may be applied for each criterion associated with the each of the one or more risk assessment parameters. At step 1322, a risk weightage score (RS) may be calculated. To this end, a risk assessment parameter score corresponding to each of the one or more risk assessment parameters is assigned, based on an associated predefined criteria and weightage. As such, a total risk scale (TRS) is obtained as a sum of risk-assessment parameter scores with weightage applied, for each of the six risk assessment parameters, as follows:

$$Total risk scale ( TRS ) = parameter - 1 score * weightage + parameter - 2 score * weightage + … . parameter - 6 score * weightage$$

At step 1324, the one or more risk assessment parameter scores corresponding to the one or more risk assessment parameters are averaged, to obtain the risk weightage score (RS) for the risk assessment, as shown below:

$$Risk weightage score ( RS ) = risk weighted score ( RS ) / number of risk assessment parameters$$

In other words, RS=TRS/6

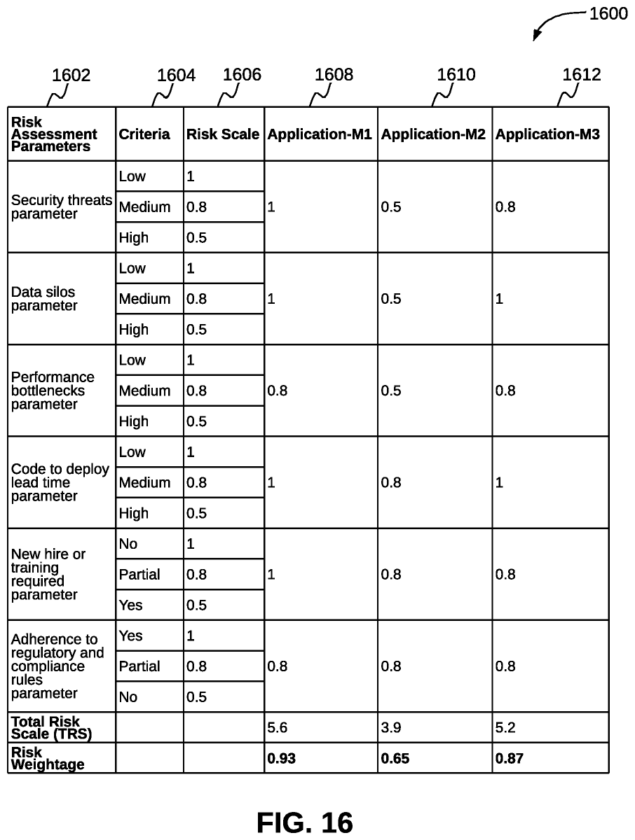

FIG. 16 illustrates a Table 1600 showing the six risk assessment parameters and the corresponding criteria and weightage for the three existing applications—Application-M1, Application-M2, and Application-M3, in accordance with some an exemplary embodiment. As shown in Table 1600, column 1602 includes the six risk assessment parameters, column 1604 includes a criteria, column 1606 includes a weightage corresponding to each criteria, column 1608 includes an risk assessment parameter score corresponding to each of the six risk assessment parameters for the Application-M1, assigned based on the criteria and the weightage, column 1610 includes a risk assessment parameter score corresponding to each of the six risk assessment parameters for the Application-M2, assigned based on the criteria and the weightage, and column 1612 includes a risk assessment parameter score corresponding to each of the six risk assessment parameters for the Application-M3, assigned based on the criteria and the weightage. The Table 1600 further shows a total risk scale (TRS) for the Application-M1, Application-M2, and Application-M3, i.e. 5.6, 3.9, and 5.2, respectively. Further, the Table 1600 shows a risk weightage score (RS) for the Application-M1, Application-M2, and Application-M3, i.e. 0.93, 0.65, and 0.87, respectively.

Referring to FIG. 13, at step 1326, a standard monolith threshold (SMT) score (corresponding to the standard threshold score) is determined based on a predefined application standard weightage score, a predefined business standard weightage score, and a predefined risk standard score, as follows:

$$Standard Monolith Threshold ( SMT ) = ( ( predefined application \\ standard weightage score + predefined business standard \\ weightage score ) / 2 ) * predefined risk standard score$$

For the monolith application, the predefined application standard weightage score (70), the predefined business standard weightage score (70), and the predefined risk standard score (0.90) is depicted in the Table 600, as shown in FIG. 6. Therefore, for Application-M1, the Application-M2, and Application-M3,

$$SLT = ( ( 70 + 70 ) / 2 ) * 0.9 = 63$$

At step 1328, a mid-value monolith threshold (MVMT) score (corresponding to the mid-value threshold score) is determined based on the standard monolith threshold (SMT), as follows:

$$Mid - value monolith threshold ( MVMT ) score = standard monolith threshold ( SMT ) score - ( standard monolith threshold ( SMT ) / 3 )$$

Therefore, for Application-M1, the Application-M2, and Application-M3,

$$MVLT = 63 - ( 63 / 3 ) = 63 - 21 = 42$$

At step 1330, a monolith threshold (MT) score is determined based on the application weightage score (WS1), the business weightage score (WS2), and the risk weightage score (RS), as follows:

$$Monolith Threshold ( MT ) = ( ( WS 1 + WS 2 ) / 2 ) * RS$$

As such, for Application-M1,

$$MT = ( ( 78.13 + 75 ) / 2 ) * 0.93 = 76.57 * 0.93 = 71.21$$

For Application-M2,

$$MT = ( ( 65.63 + 50 ) / 2 ) * 0.65 = 57.82 * 0.65 = 37.58$$

For Application-M3,

$$MT = ( ( 68.75 + 58.33 ) / 2 ) * 0.87 = 63.54 * 0.87 = 55.28$$

At step 1332, the monolith threshold (MT) score is compared with the standard monolith threshold (SMT) score and the mid-value monolith threshold (MVMT) score to identify the recommendation options. One of the plurality of predefined recommendations for the existing application is selected, based on the comparison. For example, (i) developing a new enhancement within the existing application recommendation is selected, when the monolith threshold (MT) score is greater than or equal to the standard monolith threshold (SMT) score; (ii) developing a new enhancement as a separate new application dependent on the existing application and establishing communication or integration between the new application and the existing application recommendation is selected, when the monolith threshold (MT) score is less than the standard monolith threshold (SMT) score and greater than the mid-value monolith threshold (MVMT) score; and (iii) developing a new enhancement as a complete independent application recommendation is selected, when the monolith threshold (MT) score is less than or equal to the mid-value monolith threshold (MVMT) score.

Accordingly, for the Application-M1,

$$MT ( 79.82 ) > SMT ( 72 )$$

Therefore, for Application-1, (i) developing a new enhancement within the existing application recommendation is selected.

For the Application-M2,

$$MT ( 37.58 ) < MVMT ( 42 )$$

Therefore, for Application-2, (iii) developing a new enhancement as a complete independent application recommendation is selected.

For the Application-M3,

$$MVMT ( 42 ) < MT ( 55.28 ) < SMT ( 63 )$$

Therefore, for Application-3, (ii) developing a new enhancement as a separate new application dependent on the existing application and establishing communication or integration between the new application and the existing application recommendation is selected.

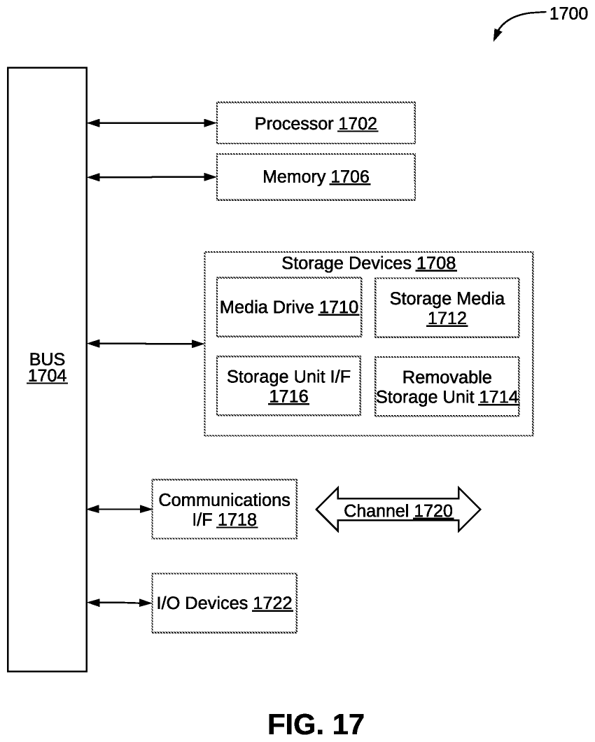

Referring now to FIG. 17, an exemplary computing system 1700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1700 may represent, for example, a user device such as a desktop, a laptop, a mobile phone, personal entertainment device, DVR, and so on, or any other type of special or general-purpose computing device as may be desirable or appropriate for a given application or environment. The computing system 1700 may include one or more processors, such as a processor 1702 that may be implemented using a general or special purpose processing engine such as, for example, a microprocessor, microcontroller or other control logic. In this example, the processor 1702 is connected to a bus 1704 or other communication media. In some embodiments, the processor 1702 may be an Artificial Intelligence (AI) processor, which may be implemented as a Tensor Processing Unit (TPU), or a graphical processor unit, or a custom programmable solution Field-Programmable Gate Array (FPGA).

The computing system 1700 may also include a memory 1706 (main memory), for example, Random Access Memory (RAM) or other dynamic memory, for storing information and instructions to be executed by the processor 1702. The memory 1706 also may be used for storing temporary variables or other intermediate information during the execution of instructions to be executed by processor 1702. The computing system 1700 may likewise include a read-only memory (“ROM”) or other static storage device coupled to bus 1704 for storing static information and instructions for the processor 1702.

The computing system 1700 may also include storage devices 1708, which may include, for example, a media drive 1710 and a removable storage interface. The media drive 1710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1712 may include, for example, a hard disk, magnetic tape, flash drive, or other fixed or removable media that is read by and written to by the media drive 1710. As these examples illustrate, the storage media 1712 may include a computer-readable storage medium having stored therein particular computer software or data.

In alternative embodiments, the storage devices 1708 may include other similar instrumentalities for allowing computer programs or other instructions or data to be loaded into the computing system 1700. Such instrumentalities may include, for example, a removable storage unit 1714 and a storage unit interface 1716, such as a program cartridge and cartridge interface, a removable memory (for example, a flash memory or other removable memory module) and memory slot, and other removable storage units and interfaces that allow software and data to be transferred from the removable storage unit 1714 to the computing system 1700.

The computing system 1700 may also include a communications interface 1718. The communications interface 1718 may be used to allow software and data to be transferred between the computing system 1700 and external devices. Examples of the communications interface 1718 may include a network interface (such as an Ethernet or other NIC card), a communications port (such as for example, a USB port, a micro-USB port), Near field Communication (NFC), etc. Software and data transferred via the communications interface 1718 are in the form of signals which may be electronic, electromagnetic, optical, or other signals capable of being received by the communications interface 1718. These signals are provided to the communications interface 1718 via a channel 1720. The channel 1720 may carry signals and may be implemented using a wireless medium, wire or cable, fiber optics, or other communications medium. Some examples of the channel 1720 may include a phone line, a cellular phone link, an RF link, a Bluetooth link, a network interface, a local or wide area network, and other communications channels.

The computing system 1700 may further include Input/Output (I/O) devices 1722. Examples may include, but are not limited to a display, keypad, microphone, audio speakers, vibrating motor, LED lights, etc. The I/O devices 1722 may receive input from a user and also display an output of the computation performed by the processor 1702. In this document, the terms “computer program product” and “computer-readable medium” may be used generally to refer to media such as, for example, the memory 1706, the storage devices 1708, the removable storage unit 1714, or signal(s) on the channel 1720. These and other forms of computer-readable media may be involved in providing one or more sequences of one or more instructions to the processor 1702 for execution. Such instructions, generally referred to as “computer program code” (which may be grouped in the form of computer programs or other groupings), when executed, enable the computing system 1700 to perform features or functions of embodiments of the present invention.

In an embodiment where the elements are implemented using software, the software may be stored in a computer-readable medium and loaded into the computing system 1700 using, for example, the removable storage unit 1714, the media drive 1710 or the communications interface 1718. The control logic (in this example, software instructions or computer program code), when executed by the processor 1702, causes the processor 1702 to perform the functions of the invention as described herein.

One or more techniques for generating recommendations for enhancement of an existing legacy or monolith application are disclosed. The techniques apply a three-dimensional assessment approach with set of parameters along with certain criteria and corresponding weightages that help to identify the appropriate recommendations for the new functionality enhancements in legacy or monolith Brownfield applications. The three-dimensional (i.e., application assessment, business assessment, and risk assessment) approach helps to perform deep analysis and understand the existing Brownfield from application, business and risk perspectives. Further, the techniques are able to derive concrete decisions from business perspective thus ensures the stability of new functionalities, quick time-to-market, and reduce cost and time, along with providing maximum return-on-investment.

It is intended that the disclosure and examples be considered as exemplary only, with a true scope and spirit of disclosed embodiments being indicated by the following claims.

What is claimed is:

1. A method of generating recommendations for enhancement of an existing application, the method comprising:
assessing, by a recommendation generating device, the existing application based on at least one of:
one or more application assessment parameters, to determine an application weightage score;
one or more business assessment parameters, to determine a business weightage score; and
one or more risk-assessment parameters, to determine a risk weightage score;
calculating, by the recommendation generating device, a threshold score based on the application weightage score, the business weightage score, and the risk weightage score; and
selecting, by the recommendation generating device, one of a plurality of predefined recommendations for the existing application, based on the threshold score.

2. The method of claim 1,
wherein the one or more application assessment parameters comprise: an existing application Lines of Code (LOC) parameter, an existing application usage or end users parameter, an availability of subject matter expert (SME) parameter, an application documentation existence parameter, a technology or framework skill set existence parameter, a technology or framework support in future parameter, a number of external systems involvement parameter, a database changes required parameter, an existing application stability parameter, an existing application complexity parameter, a flexibility in third party tool integration parameter, a new enhancement or module complexity parameter, a new enhancement or module estimated LOC parameter, a significant change in existing code base required parameter, a new enhancement or module relevance with existing modules parameter, and an existing code reusability parameter,
wherein the one or more business assessment parameters comprise: an expected additional infrastructure cost parameter, an expected additional maintenance cost parameter, a business criticality parameter, a return-on-investment prediction parameter, a time to market parameter, and a product roadmap parameter, and
wherein the one or more risk assessment parameters comprise: a security threats parameter, a data silos parameter, a performance bottlenecks parameter, a code to deploy lead time parameter, a new hire or training required parameter, and an adherence to regulatory and compliance rules parameter.

3. The method of claim 1, wherein selecting one of the plurality of predefined recommendations for the existing application further comprises:
calculating a standard threshold score based on a predefined application standard weightage score, a predefined business standard weightage score, and a predefined risk standard score;
calculating a mid-value threshold score based on the standard threshold score;
comparing threshold score with the standard threshold score and the mid-value threshold score; and
selecting one of the plurality of predefined recommendations for the existing application, based on the comparison.

4. The method of claim 3, wherein the plurality of predefined recommendations for the existing application comprise:
developing a new enhancement within the existing application recommendation;
developing a new enhancement as a separate new application dependent on the existing application and establishing communication or integration between the new application and the existing application recommendation; and
developing a new enhancement as a complete independent application recommendation.

5. The method of claim 4, wherein selecting one of the plurality of predefined recommendations for the existing application further comprises:
selecting the developing a new enhancement within the existing application recommendation, when the threshold (LT) score is greater than or equal to the standard threshold score;
selecting the developing a new enhancement as a separate new application dependent on the existing application and establishing communication or integration between the new application and the existing application recommendation, when the threshold score is less than the standard threshold score and greater than the mid-value threshold score; and
selecting the developing a new enhancement as a complete independent application recommendation, when the threshold score is less than or equal to the mid-value threshold score.

6. The method of claim 1,
wherein determining the application weightage score comprises:
assigning an application assessment parameter score corresponding to each of the one or more application assessment parameters, based on an associated predefined criteria and weightage; and
averaging one or more application assessment parameter scores corresponding to the one or more application assessment parameters, to obtain the application weightage score,
wherein determining the business weightage score comprises:
assigning a business assessment parameter score corresponding to each of the one or more business assessment parameters, based on an associated predefined criteria and weightage; and
averaging one or more business assessment parameter scores corresponding to the one or more business assessment parameters, to obtain the business weightage score, and
wherein determining the risk weightage score comprises:
assigning a risk-assessment parameter score corresponding to each of the one or more risk-assessment parameters, based on an associated predefined criteria and weightage; and
averaging one or more risk-assessment parameter scores corresponding to the one or more risk-assessment parameters, to obtain the risk weightage score.

7. A method of claim 1, wherein the existing application is one of a legacy application and a monolith application.

8. A system for generating recommendations for enhancement of an existing application, the system comprising:
a processor; and
a memory communicatively coupled to the processor, wherein the memory stores a plurality of instructions, which upon execution by the processor, cause the processor to:
assess the existing application based on at least one of:
one or more application assessment parameters, to determine an application weightage score;
one or more business assessment parameters, to determine a business weightage score; and
one or more risk-assessment parameters, to determine a risk weightage score;
calculate a threshold score based on the application weightage score, the business weightage score, and the risk weightage score; and
select one of a plurality of predefined recommendations for the existing application, based on the threshold score.

9. The system of claim 8, wherein selecting one of the plurality of predefined recommendations for the existing application further comprises:
calculating a standard threshold score based on a predefined application standard weightage score, a predefined business standard weightage score, and a predefined risk standard score;
calculating a mid-value threshold score based on the standard threshold score;
comparing threshold score with the standard threshold score and the mid-value threshold score; and
selecting one of the plurality of predefined recommendations for the existing application, based on the comparison.

10. The system of claim 9,
wherein the plurality of predefined recommendations for the existing application comprise:
developing a new enhancement within the existing application recommendation;
developing a new enhancement as a separate new application dependent on the existing application and establishing communication or integration between the new application and the existing application recommendation; and
developing a new enhancement as a complete independent application recommendation, and
wherein selecting one of the plurality of predefined recommendations for the existing application further comprises:
selecting the developing a new enhancement within the existing application recommendation, when the threshold (LT) score is greater than or equal to the standard threshold score;
selecting the developing a new enhancement as a separate new application dependent on the existing application and establishing communication or integration between the new application and the existing application recommendation, when the threshold score is less than the standard threshold score and greater than the mid-value threshold score; and
selecting the developing a new enhancement as a complete independent application recommendation, when the threshold score is less than or equal to the mid-value threshold score.

11. The system of claim 8,
wherein determining the application weightage score comprises:
assigning an application assessment parameter score corresponding to each of the one or more application assessment parameters, based on an associated predefined criteria and weightage; and
averaging one or more application assessment parameter scores corresponding to the one or more application assessment parameters, to obtain the application weightage score,
wherein determining the business weightage score comprises:
assigning a business assessment parameter score corresponding to each of the one or more business assessment parameters, based on an associated predefined criteria and weightage; and
averaging one or more business assessment parameter scores corresponding to the one or more business assessment parameters, to obtain the business weightage score, and
wherein determining the risk weightage score comprises:
assigning a risk-assessment parameter score corresponding to each of the one or more risk-assessment parameters, based on an associated predefined criteria and weightage; and
averaging one or more risk-assessment parameter scores corresponding to the one or more risk-assessment parameters, to obtain the risk weightage score.

12. A non-transitory computer-readable medium storing computer-executable instructions for generating recommendations for enhancement of an existing application, the computer-executable instructions configured for:
assessing the existing application based on at least one of:
one or more application assessment parameters, to determine an application weightage score;
one or more business assessment parameters, to determine a business weightage score; and
one or more risk-assessment parameters, to determine a risk weightage score;
calculating a threshold score based on the application weightage score, the business weightage score, and the risk weightage score; and
selecting one of a plurality of predefined recommendations for the existing application, based on the threshold score.

13. The non-transitory computer-readable medium of claim 12, wherein selecting one of the plurality of predefined recommendations for the existing application further comprises:
calculating a standard threshold score based on a predefined application standard weightage score, a predefined business standard weightage score, and a predefined risk standard score;
calculating a mid-value threshold score based on the standard threshold score;
comparing threshold score with the standard threshold score and the mid-value threshold score; and
selecting one of the plurality of predefined recommendations for the existing application, based on the comparison.

14. The non-transitory computer-readable medium of claim 13,
wherein the plurality of predefined recommendations for the existing application comprise:
developing a new enhancement within the existing application recommendation;
developing a new enhancement as a separate new application dependent on the existing application and establishing communication or integration between the new application and the existing application recommendation; and
developing a new enhancement as a complete independent application recommendation, and
wherein selecting one of the plurality of predefined recommendations for the existing application further comprises:
selecting the developing a new enhancement within the existing application recommendation, when the threshold (LT) score is greater than or equal to the standard threshold score;
selecting the developing a new enhancement as a separate new application dependent on the existing application and establishing communication or integration between the new application and the existing application recommendation, when the threshold score is less than the standard threshold score and greater than the mid-value threshold score; and
selecting the developing a new enhancement as a complete independent application recommendation, when the threshold score is less than or equal to the mid-value threshold score.

15. The non-transitory computer-readable medium of claim 12,
wherein determining the application weightage score comprises:
assigning an application assessment parameter score corresponding to each of the one or more application assessment parameters, based on an associated predefined criteria and weightage; and
averaging one or more application assessment parameter scores corresponding to the one or more application assessment parameters, to obtain the application weightage score,
wherein determining the business weightage score comprises:
assigning a business assessment parameter score corresponding to each of the one or more business assessment parameters, based on an associated predefined criteria and weightage; and
averaging one or more business assessment parameter scores corresponding to the one or more business assessment parameters, to obtain the business weightage score, and
wherein determining the risk weightage score comprises:
assigning a risk-assessment parameter score corresponding to each of the one or more risk-assessment parameters, based on an associated predefined criteria and weightage; and
averaging one or more risk-assessment parameter scores corresponding to the one or more risk-assessment parameters, to obtain the risk weightage score.
